(19) United States
(12) Patent Application Publication
(10) Pub. No.: US 2007/0180207 A1
(43) Pub. Date: Aug. 2, 2007

(54) Secure RFID backup/restore for computing/pervasive devices

(75) Inventor: Steven M. Garfinkle, Cold Spring, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 11/334,714

(22) Filed: Jan. 18, 2006

(51) Int. Cl. G06F 12/00

(52) U.S. Cl. 711/162; 235/375; 340/5.74; 340/572.1

(57) ABSTRACT

A system, method and computer program product for backing up contents of a data storage device provided in a computing device. The system is an RFID-based system comprising: an RFID device provided in the computing device and adapted for receiving and sending RFID signals, and in response to receipt of an RFID signal, the device generating an activation signal representing an instruction to backup data storage device contents of said data storage device contents in response to receipt of an RFID signal; and, a control means responsive to the activation signal received from the RFID device for invoking logic to initiate a physical copying and transmission of contents of said data storage device to a remote storage device for full or incremental backed up storage therein. By applying GPS and RFID object movement can be detected and alerts triggered and data signals generated that invokes logic to yield both a disk or data backup and purge operation.

### CROSS-REFERENCE TO RELATED APPLICATIONS

This application relates generally to applicant's commonly-owned, co-pending U.S. patent application Ser. No. ______ [Attorney Docket No. YOR920050473US1 (D#19248)] filed on even date herewith, the contents and whole disclosure of which is incorporated by reference as if fully set forth herein.

### FIELD OF THE INVENTION

This invention relates generally to the field of data security and computer data backup systems, and particularly, to a novel secure RFID technology-based Backup/Restore system for Computing/Pervasive Devices.

### BACKGROUND OF THE INVENTION

Currently, no RFID-based fully automated backup data solution exists for computer/pervasive devices.

One conventional RFID-based solution for backing data in computer/pervasive devices is described in U.S. Patent Publication No. 2004/0188512 which is directed to an RFID controlled device for managing storage. However, the system described in this reference does not take into account password security for user initiated recovery or recovery of pervasive devices containing other types of media. Moreover, the system described in U.S. Patent Publication No. 2004/0188512 assumes that the device is administrator managed.

U.S. Pat. No. 6,870,797 is a transponder-based cartridge system that does not take into account password security for user initiated recovery or recovery of pervasive devices containing other types of media. Moreover, this reference does not address delta backups and is only used for controlling data cartridges.

It would be highly desirable to provide a computer/pervasive device user with the ability to post full or intermittent backups via the intermediary of RFID-based technology to a remote disconnected computer (e.g., a server).

### BRIEF SUMMARY OF THE INVENTION

The present invention provides an RFID-based solution for providing user-specified or automated data backup and recovery in a computer or computer-related device.

Particularly, an RFID technology-based detection system and method is provided that enables a computer/pervasive device user with the ability to post full and intermittent backups throughout a user defined period, e.g., 24 hour period, to a remote disconnected computer system, e.g., a server.

More particularly, the invention relates to a system, method and computer program product for backing up contents of a data storage device provided in a computing device. The system is an RFID-based system comprising: an RFID device provided in the computing device and adapted for receiving and sending RFID signals, and in response to receipt of an RFID signal, the device generating an activation signal representing an instruction to backup data storage device contents of the data storage device contents in response to receipt of an RFID signal; and, a control means responsive to the activation signal received from the RFID device for invoking logic to initiate a physical copying and transmission of contents of the data storage device to a remote storage device for full or incremental backed up storage therein. By applying GPS and RFID object movement can be detected and alerts triggered and data signals generated that invokes logic to yield both a disk or data backup and purge operation.

In addition, the system and method of the invention permits a full recovery of a drive in the event the drive is wiped clean without the need of boot-up software. This is achieved by inserting RFID technology that can grab requisite software to bootstrap the drive and enable a recovery from the remote system. This would be enabled within corporate sites, airports, specific and general locations, locally and globally. In addition to providing full restores, specific files could be restored per user request all with password protection and encryption.

In one embodiment, a data backup is initiated automatically upon detection of a triggering event.

In another embodiment of the invention, an RFID signal is initiated by a user that is remotely located from the computing device.

In a further embodiment of the invention, the computing device includes a satellite navigation receiver configured for receiving position determining signals from a satellite based navigation system and determining a position of the computer device; and, a means for comparing the determined position with a predetermined position, wherein a detected triggering event including a determination that a location of said computer device has changed relative to the predetermined position. By applying GPS and RFID, a location can be detected and wireless communication provided with instructions to establish data transfer, disk back-up, or recovery.

Advantageously, data transmissions using RIFD technology according to the invention can be used to send only delta changes or specific files based on user request or preset rules. Fortuitously, this removes the guess work out of creating a system backup and allows the user to focus on the work at hand and not be concerned about backups.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a general schematic diagram of a computer related device 12 having Sense and Respond RFID Backup and Restore capabilities according to the invention;

FIG. 2 is a conceptual diagram detailing operation of the Sense and Respond RFID Backup and Restore system 10 according to the present invention;

FIGS. 3A-3E illustrate flow charts depicting the methodology implemented by the Sense and Respond RFID Backup and Restore system 10 according to the invention.

### DETAILED DESCRIPTION OF THE INVENTION

The invention provides for the physical backup of data stored on a media storage device that can be automatically initiated through an RFID Sense and Respond process or, alternatively, triggered by a user (e.g., an owner) of the computing device having the media storage unit(s) either via a server or by a satellite based (e.g., GPS) location detection of the device. The invention additionally provides for the physical restoration of data on a media storage device that can be automatically initiated through an RFID Sense and Respond process triggered by a user (e.g., owner) of the computing device having the media storage unit(s) either via a server or by a satellite based (e.g., GPS) location detection of the device.

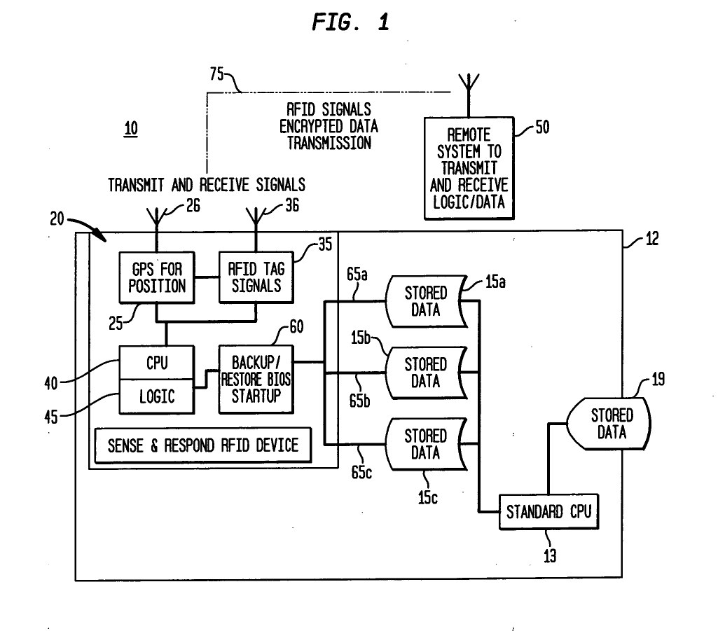

Aspects of the invention will be described with reference to FIG. 1, which is a general schematic diagram of a computer related device 12 having Sense and Respond RFID Disk Backup and Restore capabilities according to the invention. Particularly, a computing device 12, which may represent any stationary or mobile computing device (e.g., laptop, notebook, personal computer, server, etc.) includes a central processing unit (CPU) 13 executing an operating system program, e.g., Windows, Linux, UNIX and like variants, and a user interface (e.g., display) device 19, and, additionally includes data, programs and information stored in a data storage media, such as hard disk drives 15a, . . . , 15c that is physically part of the computing device. This device is implemented with a Sense and Respond RFID module 20 for initiating the data backup and restore functionality according to the invention.

The Sense and Respond RFID device 20 particularly includes an RFID Tag system including an RFID tag device, including an RFID transponder device 35, for receiving interrogation signals from a remote system 50 that includes an RFID interrogator device and/or like device adapted for communicating RFID and other signals, e.g., via antenna device 36. Included in system 50 includes an RFID transponder and/or interrogator device including a transceiver, decoder and antenna configured to emit a signal that activates the RFID tag so it can read data from and write data to the RFID transponder 35. While typically a passive device (i.e., RFID transponder 35 absorbs energy to power its circuitry from the received interrogation signals), the transponder may be configured to be a read-only or a read/write type and may have a battery or like power supply source (not shown). The RFID transponder device 35 may be fabricated as an ASIC on a single silicon chip including a receiver/transmitter and controller circuitry along with an associated attached memory device. The memory stores an identification code, or other data related to the particular computing device to which it corresponds. The transponder may alternately comprise a collection of integrated components: tag, antenna, logic for reader and controller, requisite software systems, etc.

The Sense and Respond RFID device 20 additionally includes a global positioning system (GPS) receiver device 25 for receiving satellite data signal transmissions via a suitable antenna device 26, e.g., GPS signals (not shown), and, as known in the art, includes processing functionality for determining the location of the computing related device 12 from the satellite data signal transmissions received. It is appreciated that receiver device 25 may comprise any satellite navigation system receiver device employed for receiving signals from three or more satellites implemented in satellite navigation systems such as GPS, GLONASS, and Galileo and like satellite-based transmission signals and for determining location or position coordinates (e.g., latitude and longitude) of the computing device 12. In the preferred embodiment, position coordinate data of the device 12 may be determined by processing in the receiver device 25 itself, or by the CPU device 40 coupled to the receiver 25.

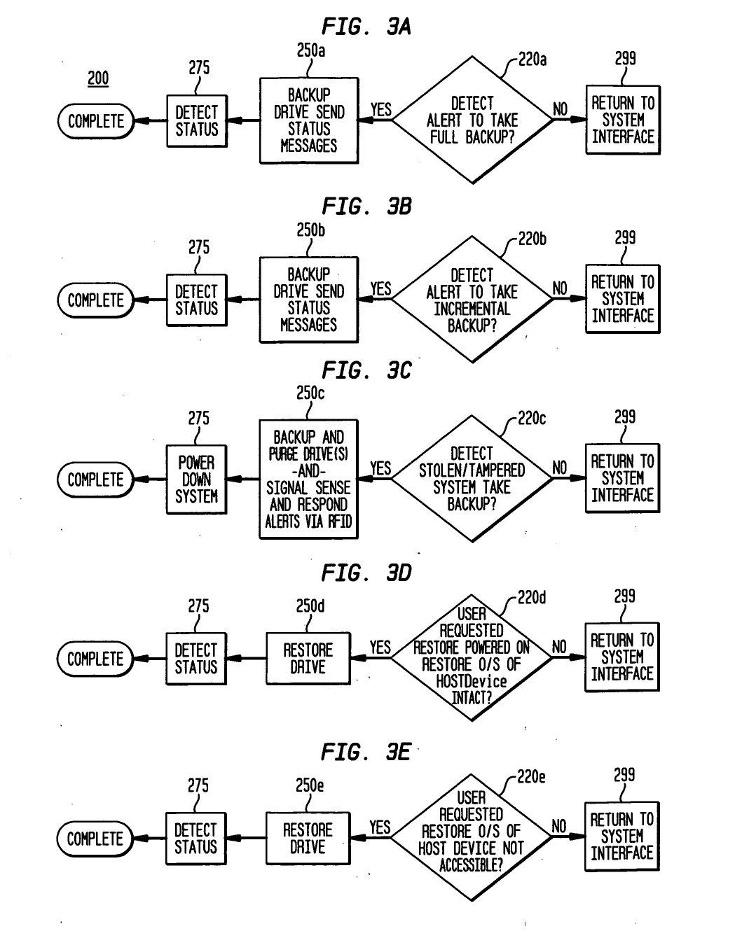

Controlling operation of the Sense and Respond RFID device 20 generally and the satellite-based positioning receiver is a microcontroller device or CPU 40 having an associated memory for storing logic 45 (e.g., rules) implementing the functionality for RFID Sense and respond backup and recovery functionality as will be described in greater detail herein with respect to FIGS. 3A-3E.

In typical operation, in response to receiving an interrogation signal 75, the microcontroller or CPU 40 is enabled to perform control and data processing for the Sense and Respond RFID device 20 according to programmed logic 45. In one embodiment, transponder device 35 and may initially transmit an identification code and/or other data from its memory back to the remote interrogating system 50, or other transponder devices. This is performed in combination with software logic in combination with a Sensor/Actuator (used for external inputs and outputs) and is required to alert instructions to systems and devices to trigger events, such as processes to backup or purge data, or initiate other remote triggers to incite actions, thus delivering sense and respond scenarios. More particularly, as will be described in greater detail herein below, according to the invention, the RFID transponder 35 is further configured to send an “action” signal to another transponder or other devices to perform certain functions. In the context of the invention, an “action” signal is generated and communicated along signal lines 65a, . . . , 65c to execute a respective data backup operation of all data on connected hard disk drives 15a, . . . , 15c, respectively. Thus, for instance, as shown in FIG. 1, the logic executed by microcontroller 40 will automatically activate a “Backup/restore BIOS Start-up” module 60 that interfaces with the computing device's operating system to initiate performance of functions to backup some or all of the data included on a storage media (e.g., a hard disk drive 15a-15c) or restore data back to the hard disk drive 15a-15c from an external or remote system 50. More particularly, the backup/restore (basic input/output system) BIOS module 60 executes logic to initiate a physical transmission of a copy or image of the data stored in the hard disk storage, i.e., to a remote backup or recovery device such as the local or remote backup recovery server 150. Alternately, the backup/restore BIOS module 60 executes logic to initiate a physical transmission of a copy or image of the data stored at the remote backup recovery server 150 back to the hard disk storage device. The logic causing this execution is stored at the physical level to ensure functionality. Since the logic is at the BIOS level it can not be modified at a software level and may be initiated outside of the normal operating system.

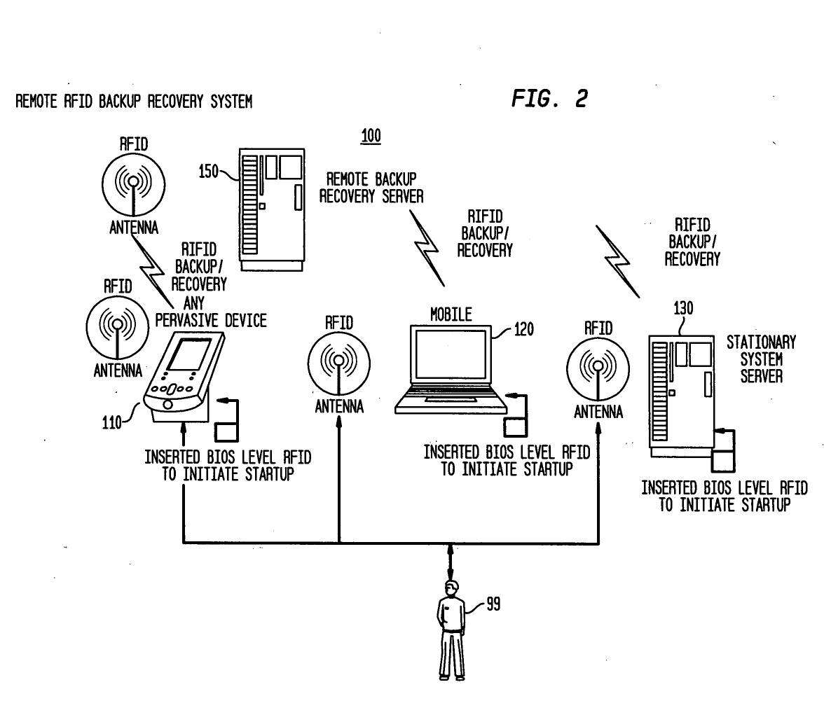

In the conceptual diagram depicting the operation of the Sense and Respond RFID Disk Backup and Recovery system 100 of FIG. 2, a Sense and Respond Radio Frequency Identification (RFID) device 20 of FIG. 1 may be implemented in computing devices including, but not limited to: a pervasive devices 110 (e.g., a personal digital assistant or PDA), a mobile device 120 (e.g., laptop or notebook computer), system server devices 130, etc. Each pervasive device 110, mobile device 120, or system server device 130 includes a respective Sense and Respond RFID device (FIG. 1) for receiving sense and respond RFID interrogations and initiating functionality for automatically backing up data contained in the hard disk drives of the respective computing device and transmitting the backed up data to a local or remote backup recovery server 150. Alternately, or in addition, a sense and respond RFID interrogation may be received that will initiate functionality for automatically restoring data back to the hard disk drives of the respective computing device by receiving data transmissions from the local or remote backup recovery server 150. Particularly, a “Sense and Respond” initiation can be automatically triggered, triggered by an authorized computer user 99 remotely, or triggered in response to receipt of location detection information using the satellite-based navigation system (e.g., GPS). Preferably, in response to an interrogation by an authorized computer user 99 or, by automated means as will be described in greater detail hereinbelow, the BIOS level Sense and Respond RFID functionality initiates, by activating the Backup and Recovery BIOS module 60, a backup or recover process that physically copies data to or transmits copies of data from the hard disk. By specifying certain parameters, incremental or whole hard disk drive copies/restorations may be performed. The system can backup entire drives or other memory devices and or/select files.

Data may be backed up or restored via one or more communications modalities. For instance, primary communication between the local or remote backup recovery server 150 and each device 110, 120 or 130 is via RFID signals transmitted/received via the RFID tag device 35; however, FIG. 2 is not so limited in that each device 110, 120 or 130 may be configured for wired switching, or switching via ethernet (LAN or WAN) connections, or standard wireless connection be optionally engaged, if such a communications means is detected.

Moreover, as would be known to skilled artisans, the inserted BIOS level Sense and Respond RFID module can further initiate system start up. That is, a system may be bootstrapped without preloaded software. Thus, if there is no operating system detected using the standard system, the system will be able to boot up and through RFID signals; there is provided enough logic to restore or build a functional drive on a computer.

FIGS. 3A-3E denote exemplary processes 200 implemented by the logic executed by the CPU 40 in the RFID Sense and Respond device 20 for data backup and recovery operations, or, alternatively, logic executed by the device CPU 13 (as shown in FIG. 2) of each computer related device 12.

As shown in FIG. 3A, in a first step 220a, the device implements logic for evaluating whether an alert has be received or a data backup or restore condition is detected. For example, an alert may be generated and received to initiate a full data backup condition in response to received satellite navigation system data received by the GPS receiver indicating movement of the computer device. Other types of alerts may be generated with the device implementing logic for initiating a memory backup from or data restoration to the hard disk(s) based on numerous other alert criteria including, but is not limited to, the following: a user initiated trigger (automatically according to a predetermined time schedule, e.g., every 5 minutes, every 1 hour, etc., or “on-demand”); a detected temperature change; a detection of more than three (3) or “n” times of a password entry; or, an alert triggered via an email to the system. Continuing in FIG. 3A, a next step 275 may include detecting a corresponding status message and implementing any further processing as may be required by appropriate the appropriate status. Generally, a status message is a semiphore to indicate events that have occurred and whether these events achieved success or failed. The system logic would set these messages, e.g., “backup successfully complete”, or “system has been tampered with”, etc. Detecting a status thus may entail testing the semiphore to determine the systems state message. As further shown in FIG. 3A, if an alert has not been detected, at step 220a, the system is returned back to its current state at step 299, i.e., the system continues to function as normal with the end-user not noticing any change.

Likewise, as shown in FIG. 3B, at step 220b, the device implements logic for evaluating whether an alert has be received or a data backup or restore condition is detected, as in step 220a. However, in the embodiment depicted in FIG. 3B, an incremental data backup or restore operation is performed at step 250b in response to a received alert. In this embodiment, it is understood that the computer related device 110, 120 or 130 will keep a log that registers new writes to memory sectors after a full backup is taken, the log (not shown) including addresses and associated data lengths—enabling backup of select files, for example in response to the detected alert. Continuing in FIG. 3B, a next step 275 may include detecting a corresponding status message and implementing any further processing as may be required by appropriate the appropriate status. As further shown in FIG. 3B, if an alert has not been detected, at step 220b, the system is returned back to its current state at step 299, i.e., the system continues to function as normal with the end-user not noticing any change.

Further, as shown in FIG. 3C, at step 220c, the device implements logic for determining whether the system has been stolen or tampered with warranting a full data backup. In one scenario, described herein with respect to FIG. 3A, an alert may be detected that the computing device has either been stolen or tampered with, or both, warranting a full data backup. Determination of it being stolen is accomplished by receipt of satellite-based navigation system signals that aid in calculating the position of the device 12 and whether the device has changed in relation to a preset location or origin, or is outside a predetermined boundary, range or radius, indicating potentially that the device has been stolen. Particularly, logic is implemented by the CPU 40 in the Sense and Respond RFID device 20 to determine if the calculated determined location is not detected to be outside or within a preset range or, meets or exceeds a preset location relative to an origin programmed into the device, for example. Upon determining the position of the device, a corresponding alert may then be generated within RFID device 20 to initiate a full disk backup operation and send appropriate status messages as depicted at step 250c. It should be understood that in the exemplary embodiment described, the activation of the satellite based (e.g., GPS) receiver device for receiving satellite system based signals and calculating position/location coordinates may be automated, e.g., periodically, or initiated by a user, or both. After initiating the disk backup, an additional disk purge process may be initiated via functionality as described in applicants' related co-pending U.S. Ser. No.______ [Attorney Docket No. YOR920050473US1 (D#19248)] incorporated as if fully set forth herein. That is, step 250c contemplates receipt of a further data purge request signal via the RFID interrogator device and, in response, a disk purge is initiated by generating the appropriate sense and respond action signals via the Sense and Respond RFID device 20, e.g., purge data contents or destroy disk head. Continuing in FIG. 3C, a next step 275 may include powering down the system components. As further shown in FIG. 3C, if it is determined that the system has not been tampered with or stolen at step 220c, the system is returned back to its current state at step 299, i.e., the system continues to function as normal with the end-user not noticing any change.

In a further embodiment, the RFID tag device implements logic for determining whether the user has requested or triggered a data restore operation regardless of whether the Operating system (O/S) of the host device is intact as shown in FIG. 3D, at step 220d, or, whether the O/S host device is not accessible as shown in FIG. 3E, at step 220e. For example, in FIG. 3D, in an example implementation, if the operating system of the computer related device (host) is functioning, then the user can initiate a restore that does not include loading down the operating system (at step 220d). In FIG. 3E, if the operating system cannot be detected, e.g., the user has replaced a disk drive with a brand new one, but has a backup on the remote system, then the user can start up the system to get the O/S on the drive and proceed with the restore operation. In each scenario, a user may request a backup operation via user-defined rules that would trigger automatic backups/restorations according to a predetermined time schedule, e.g., every 5 minutes, every 1 hour, etc. In response to receipt of an alert request, in the embodiments depicted in FIGS. 3D and 3E, a full drive restore operation is performed at respective step 250d, 250e in response to a received alert. According to Figure in the embodiment depicted, each process may implement a next step 275 that includes detecting a corresponding status message and implementing any further processing as may be required by appropriate the appropriate status. As further shown in FIGS. 3D and 3E, if a user request has not been detected either step 220d or 220e, the system is returned back to its current state at step 299, i.e., the system continues to function as normal with the end-user not noticing any change.

Besides the types of alerts mentioned with respect to FIGS. 3A and 3B, the device may implement logic for initiating a memory backup/data restore to the hard disk(s) or, a disk purge, based on numerous other criteria including, but not limited to, the following criteria: 1) a user initiated transmit remote signal to purge; 2) detection of an invalid system password entry, or detecting a number of log-in attempts exceeding a threshold number of tries; 3) detection of an invalid search password, or detecting a number of invalid search attempts exceeding a threshold number of tries; 4) detection of invalid random usage of a password, or detecting a number of invalid random usage attempts exceeding a threshold number of tries; 5) detection of a long running task to scan any cookies residing in memory; 6) detection of invalid long running task password, or detecting a number of invalid long running task password attempts exceeding a threshold number of tries; 7) detection of meeting a user defined security criteria, or detection of exceeding a number of attempts to circumvent a user defined security criteria; 8) detection of a long running task to scan any cookies residing in memory; 9) detection of an attempt or a number of attempts exceeding a number of tries threshold to remove the hard drive itself; or, 10) detection of a user having unauthorized registry access. In each instance, a purge trigger event, disk data purge(s) may be initiated after backing up the respective data go to be purged by generating the appropriate signal sense and respond action signals via the Sense and Respond RFID device 20, i.e., an RFID signal is used to initiate the backup/restore or purge process.

Thus, it is within the scope of the invention that any detectable criteria or patterns may initiate a disk data backup or restore operation. That is, any given event that can be “sensed” by the system and initiate a “response” to either correct a situation or protect a resource, is contemplated. Other events include occurrences such as detected tampering, theft, vibrations, temperature changes, and even detection of human conversation and movement in proximity to the device, i.e., such events that can be sensed using the apparatus with responses signaled using RFID to invoke remote services in order to initiate data backup, recovery and purge drive processes. Additional criteria or patterns include: 1) implementation of user defined questions/answers; 2) detection of executing of password cracking software (storing process names); 3) detection of executing keystroke logging software; 4) detection of login spoofing; 4) detection of decryption attempts; and, detection of dictionary attacks, for instance.

Applying the technology of the invention to software logic, sense and response signals are used to initiate a disk backup/restoration wither with or without a purge based on system provided criteria. By applying GPS and RFID, object movement can be detected and alerts triggered and through data signals, logic can be invoked to yield a disk backup and data purge thus ensuring a compromised device has no recoverable or accessible data. The logic executed within such device 12 interprets transmitted or received signals and then triggers automated processes to yield data backup/restore or purge disk results.

The advantages of this invention over traditional backup and recovery systems include the ability to work in an “On Demand” fashion, without the end-user having to initiate, monitor or, have the media storage device physically connected to the backup system. In addition, via the RFID based Sensed and respond backup and recovery functionality, a user can restore the drive remotely, e.g., if the user is traveling and the disk needs to be recovered.

This invention could be used to restore a disk in the event the system is compromised and data is caused to be physically deleted by an associated secure disk purge system such as described in applicants' related co-pending U.S. Ser. No.______ [Attorney Docket No. YOR920050473US 1 (D#19248)]. In an embodiment of the invention, BIOS level detection is tied with RFID technology such that a password is requested to initiate a data restore.

This system may additionally be used to deploy software in the event that a standard Internet connection (such as a LAN connection) could not be established on a system due to unavailable software. This invention would also help streamline system setups without the need to load base software directly, e.g., through installed CD ROM devices and other peripherals.

The present invention has been described with reference to diagrams of methods, apparatus (systems) and computer program products according to embodiments of the invention. It will be understood that each diagram can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified herein.

These computer program instructions may also be stored in a computer-readable memory that can direct a computer or other programmable data processing apparatus to function in a particular manner, such that the instructions stored in the computer-readable memory produce an article of manufacture including instruction means which implement the functions specified herein.

The computer program instructions may also be loaded onto a computer-readable or other programmable data processing apparatus to cause a series of operational steps to be performed on the computer or other programmable apparatus to produce a computer implemented process such that the instructions which execute on the computer or other programmable apparatus provide steps for implementing the functions specified herein.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

What is claimed is:

1. An RFID-based data backup and recovery system for a computing device having a data storage device, said system comprising:
an RFID device provided in said computing device adapted for receiving and sending RFID signals, and in response to receipt of an RFID signal, said device generating an activation signal representing an instruction to backup data storage device contents; and,
control means responsive to said activation signal received from said RFID device for invoking logic to initiate a physical copying and transmission of contents of said data storage device to a remote storage device for backed up storage therein.

2. The system as claimed in claim 1, wherein said activation signal represents an instruction to restore device contents to said data storage device, said control means responsive to said activation signal received from said RFID device for invoking logic to initiate a physical transmission of contents stored at said remote storage device to said data storage device to restore backed up data contents to said data storage device.

3. The system as claimed in claim 1, wherein said one RFID signal is initiated by a user that is remotely located from said computing device.

4. The system as claimed in claim 1, wherein said control means executes logic stored at a physical level of said computing device, the logic implementing BIOS level of functionality.

5. The system as claimed in claim 1, wherein said data is physically transmitted between said remote storage device for backed up storage therein via RFID signals.

6. The system as claimed in claim 4, wherein said BIOS level of functionality enables bootstrapped start up of said host computing device.

7. The system as claimed in claim 1, wherein said computing device further comprises:
a satellite based navigation position receiver configured for receiving position determining signals from a satellite based navigation system and determining a position of said computer device; and,
means for comparing said determined position with a predetermined position data stored in said device, wherein said activation signal representing an instruction to backup contents of data storage device is generated in response to a determination that a location of said computer device has changed relative to said predetermined position.

8. The system as claimed in claim 7, wherein said control means invokes further logic to initiate a further purging of said data contents from said data storage device after backing up said data contents.

9. The system as claimed in claim 1, wherein said control means is responsive to a detected trigger event for automatically initiating backup of said data storage device to said remote storage device.

10. The system as claimed in claim 5, wherein a trigger event includes: detection of an invalid system password entry, detection of a number of log-in attempts exceeding a threshold number, detection of an automatically generated periodic trigger or, detection of an on-demand trigger event, or, detection of an occurrence of one or more of: computer device tampering, theft, vibration, a temperature change, or detection of human conversation and movement in proximity to the computing device.

11. The system as claimed in claim 1, wherein a computing device comprises one or more of: a pervasive digital device, a laptop computer, a notebook computer, a personal computer, or a server device.

12. The system as claimed in claim 1, configured for performing an incremental backup of data storage device contents.

13. A method for backing up contents of a data storage device provided in a computing device, said method comprising:
providing an RFID device in said computing device adapted for receiving and sending RFID signals;
generating an activation signal representing an instruction to backup data storage device contents of said data storage device contents in response to receipt of an RFID signal; and,
invoking logic to initiate a physical copying and transmission of contents of said data storage device to a remote storage device for backed up storage therein.

14. The method as claimed in claim 13, further including: invoking logic to initiate a physical transmission of contents stored at said remote storage device to said data storage device to restore backed up data contents to said data storage device.

15. The method as claimed in claim 1, further including: enabling a user to initiate generation of an RFID signal for receipt by said RFID device while remotely located from said computing device.

16. The method as claimed in claim 13, wherein said wherein said invoking logic includes: executing logic stored at a physical level of said computing device, the logic implementing BIOS level of functionality.

17. The method as claimed in claim 1, wherein said contents of said data storage device are transmitted to said remote storage device for backed up storage therein via RFID signals.

18. The method as claimed in claim 16, implementing said BIOS level of functionality for enabling bootstrapped start up of said computing device.

19. The method as claimed in claim 13, wherein said computing device further comprises:
receiving position determining signals from a satellite based navigation system to determine a position of said computer device; and,
comparing said determined position with a predetermined position data stored in said device, said activation signal representing an instruction to backup contents of data storage device is generated in response to a determination that a location of said computer device has changed relative to said predetermined position.

20. The method as claimed in claim 19, further including: invoking further logic to initiate a purging of said data contents from said data storage device after backing up said data contents to said remote storage device.

21. The method as claimed in claim 13, further comprising: responding to a detected trigger event for automatically initiating backup of said data storage device to said remote storage device.

22. The method as claimed in claim 21, wherein a trigger event includes: detection of an invalid system password entry, detection of a number of log-in attempts exceeding a threshold number, detection of an automatically generated periodic trigger or, detection of an on-demand trigger event, or, detection of an occurrence of one or more of: computer device tampering, theft, vibration, a temperature change, or detection of human conversation and movement in proximity to the computing device.

23. The method as claimed in claim 13, wherein said physical transmission of contents comprise an incremental backup of data storage device contents.

24. A computer program product comprising a computer usable medium including computer usable program code for backing up contents of a data storage device provided in a computing device, said computer program product including:
computer usable program code for adapting an RFID device in said computing device for receiving and sending RFID signals;
computer usable program code for generating an activation signal representing an instruction to backup data storage device contents of said data storage device contents in response to receipt of an RFID signal; and,
computer usable program code for invoking logic to initiate a physical copying and transmission of contents of said data storage device to a remote storage device for backed up storage therein.
